(19) United States
(12) Patent Application Publication
(10) Pub. No.: US 2025/0085126 A1
(43) Pub. Date: Mar. 13, 2025

(54) Route Finder Utility

(71) Applicant: Runback LLC, Rockville Centre, NY (US)

(72) Inventor: William E Mohr, Rockville Centre, NY (US)

(73) Assignee: Runback LLC, Rockville Centre, NY (US)

(21) Appl. No.: 18/243,228

(22) Filed: Sep. 7, 2023

(51) Int. Cl. G01C 21/34; G01C 21/36; H04W 76/50

(52) U.S. Cl. CPC G01C 21/3484; G01C 21/3423; G01C 21/3461; G01C 21/362; G01C 21/3694; H04W 76/50

(57) ABSTRACT

Described herein are examples of a route finder utility configured to provide routes for walking, running, bicycling, rollerblading or other means of locomotion. The route finder utility can suggest routes based on desired distance, location, and/or stopovers. The route finder utility allows users to locate exercise routes in unfamiliar locations and/or provide new routes in a familiar location.

### BACKGROUND

Digital mapping features have been ubiquitous on computers since the beginning of the internet era. Modern smart phones provide navigation capabilities for pedestrians, bicycles, automobiles, and even public transportation. Determining distances between locations of interest can be accomplished via multiple known systems. Many existing systems provide information for exercise, such as tracking running or biking routes in real time and providing information on the route afterwards. These systems can be available on smart devices including phones, tablets, watches and/or other wearables.

### BRIEF DESCRIPTION OF THE DRAWINGS

The present description will be understood more fully when viewed in conjunction with the accompanying drawings of various examples of route finder utilities. The description is not meant to limit the route finder utilities to the specific examples. Rather, the specific examples depicted and described are provided for explanation and understanding of route finder utilities. Throughout the description the drawings may be referred to as drawings, figures, and/or FIGs.

FIG. 1 illustrates a route finder utility, according to an embodiment.

FIG. 2 illustrates a device schematic for various devices used in the route finder utility 100, according to an embodiment.

FIG. 3 illustrates a home graphical user interface, for entering information about a desired route on a client device, according to an embodiment.

FIG. 4 illustrates a view routes graphical user interface, according to an embodiment.

FIG. 5 illustrates a view route graphical user interface, with an add stopover graphical container, according to an embodiment.

FIG. 6 illustrates an embodiment of the view routes graphical user interface indicating a stopover, according to an embodiment.

FIG. 7 illustrates a view routes graphical user interface including a route completed graphical container, according to an embodiment.

FIG. 8 illustrates the view route graphical user interface including a save route graphical container according to an embodiment.

FIG. 9 illustrates a my routes graphical user interface according to an embodiment.

FIG. 10 illustrates a profile graphical user interface, according to an embodiment.

FIG. 11 illustrates a flow chart depicting method steps for the route finder utility according to an embodiment.

### DETAILED DESCRIPTION

A route finder utility as disclosed herein will become better understood through a review of the following detailed description in conjunction with the figures. The detailed description and figures provide merely examples of the various embodiments of route finder utilities. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Conventional exercise software utilities, such as ones suitable for smart devices, e.g., smart phones and/or smart watches, can include systems and methods for tracking exercise routes in real time. The smart device via the use of global positioning systems (GPS) can track the user during a run, bike, walk, or other activity and provide a map of the route as well as distance, speed, and other variables. Alternatively, mapping utilities can be employed to create a route by dragging a cursor (or finger on a touchscreen) around a map. The second method will allow you to create a route and then provide the distance for the route provided.

The existing conventional systems do not provide systems or methods that allow utilities (or software applications) to create a route based on a predetermined distance and predetermined start and end points. Further, existing systems for creating predetermined routes are essentially unusable when the user is unfamiliar location, such as a vacation destination or work location.

Implementation of route finder utilities according to the present invention may address some or all of the problems described above. A route finder utility can be configured to accept input information, such as a predetermined distance, e.g., 5 k, 5 miles, 7.5 miles, etc. . . . , and provide a route from location A and back to location A for a distance of 5 k. Alternatively, the route finder utility can be configured to provide a 5 k route from location A and ending at a second location B. Stops can be added at points along the route, the distance can be varied, and the starting and stopping locations can be varied.

The route finder utility solves problems related to boredom with repetitive routes for workout enthusiasts, and also solves the problem of finding a route for a desired distance in an unfamiliar location. Additionally, the route finder utility provides a safe route the does not involve major highways or congested arteries and can be configured to avoid areas with known dangers, such as areas with high crime rates or high levels of pedestrian accidents.

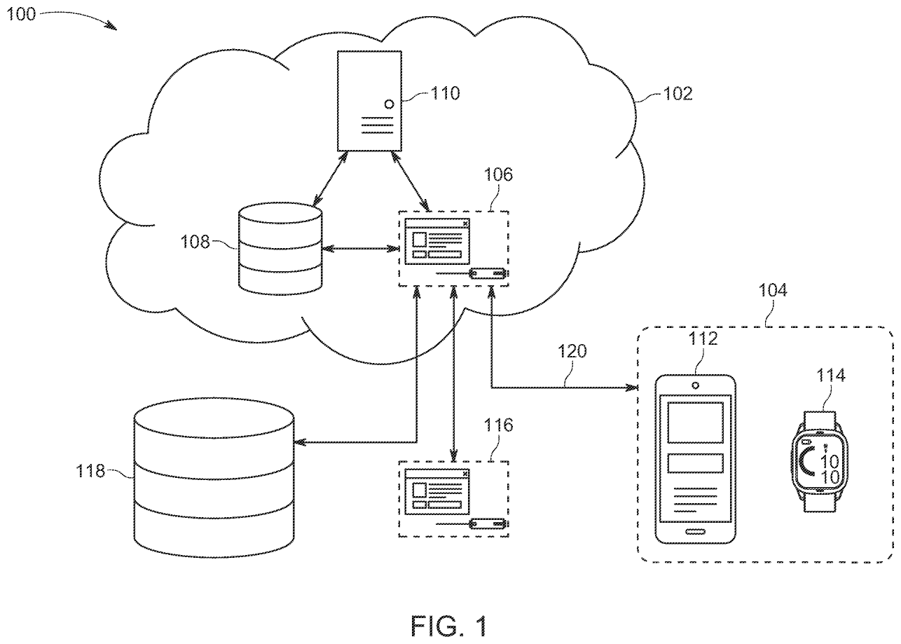

FIG. 1 illustrates a route finder utility 100, according to an embodiment. The route finder utility 100 includes internal and external data resources for creating routes. The route finder utility 100 may result in reduced memory allocation at client devices and may conserve memory resources for application servers.

The route finder utility 100 may include a cloud-based data management system 102 and a user device 104. The cloud-based data management system 102 may include an application server 106, a database 108, and a data server 110. The user device 104 may include one or more devices associated with user profiles of the route finder utility 100, such as a smartphone 112 and/or a smart watch 114. The route finder utility 100 may include external resources such as an external application server 116 and/or an external database 118. The various elements of the route finder utility 100 may communicate via various communication links 120. An external resource may generally be considered a data resource owned and/or operated by an entity other than an entity that utilizes the cloud-based data management system 102 and/or the user device 104.

The route finder utility 100 may be web-based. The user device 104 may access the cloud-based data management system 102 via an online portal set up and/or managed by the application server 106. The route finder utility 100 may be implemented using a public internet. The route finder utility 100 may be implemented using a private intranet. Elements of the route finder utility 100. such as the database 108 and/or the data server 110, may be physically housed at a location remote from an entity that owns and/or operates the route finder utility 100. For example, various elements of the route finder utility 100 may be physically housed at a public service provider such as a web services provider. Elements of the route finder utility 100 may be physically housed at a private location, such as at a location occupied by the entity that owns and/or operates the route finder utility 100.

The communication links 120 may be direct or indirect. A direct link may include a link between two devices where information is communicated from one device to the other without passing through an intermediary. For example, the direct link may include a Bluetooth™ connection, a Wifi Direct™ connection, a Zigbee® connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 120, may refer to any of the aforementioned indirect communication links.

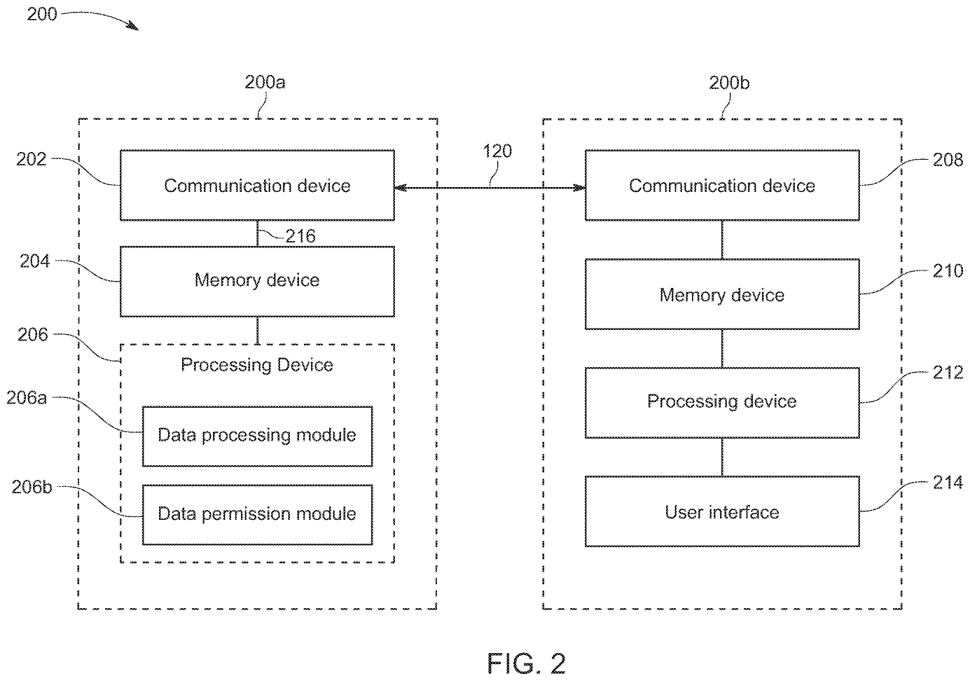

FIG. 2 illustrates a device schematic 200 for various devices used in the route finder utility 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data permissions module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, and address bus, and so forth. The communication device 202 of the server device 200a may communicate with the communication device 208 of the client device 200b.

The data processing module 206a may handle inputs from the client device 200a. The data processing module 206a may cause data to be written and stored in the memory device 204 based on the inputs from the client device 200b. The data processing module 206a may retrieve data stored in the memory device 204 and output the data to the client device 200a via the communication device 202. The data permissions module 206b may determine, based on permissions data stored in the memory device, what data to output to the client device 200b and what format to output the data in (e.g., as a static variable, as a dynamic variable, and so forth). For example, a variable that is disabled for a particular user profile may be output as static. When the variable is enabled for the particular user profile, the variable may be output as dynamic.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the smart watch 114. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the route finder utility 100. Elements of the route finder utility 100 may include data storage and/or processing capabilities. Such capabilities may be rendered by various electronics for processing and/or storing electronic signals. One or more of the devices in the route finder utility 100 may include a processing device. For example, the cloud-based data management system 102, the user device 104, the smartphone 112, the smart watch 114, the external application server 116, and/or the external database 118 may include a processing device. One or more of the devices in the route finder utility 100 may include a memory device. For example, the cloud-based data management system 102, the user device 104, the smartphone 112, the smart watch 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the route finder utility 100. Such memory allocation may be based on instructions stored in the memory device. Memory resources at a specific device may be conserved relative to other systems that do not associate variables and other objects with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

The devices in the route finder utility 100 may include data communication capabilities. Such capabilities may be rendered by various electronics for transmitting and/or receiving electronic and/or electromagnetic signals. One or more of the devices in the route finder utility 100 may include a communication device, e.g., the communication device 202 and/or the communication device 208. For example, the cloud-based data management system 102, the user device 104, the smartphone 112, the smart watch 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™M programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the route finder utility 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the route finder utility 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the route finder utility 100 and/or various elements of the route finder utility described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the route finder utility 100.

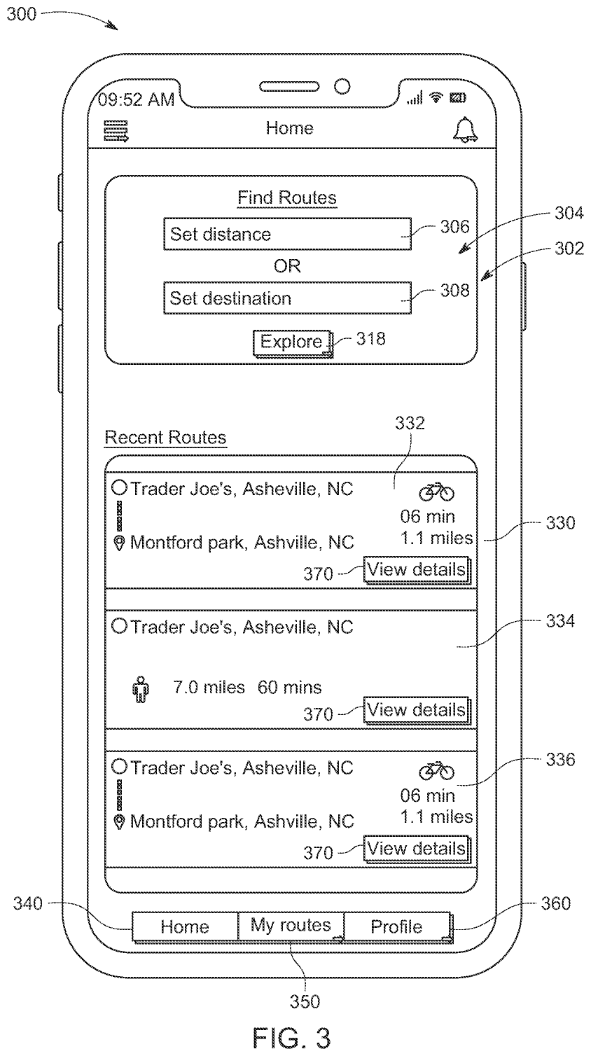

FIG. 3 illustrates a home graphical user interface 300 (home GUI 300) of an application for entering information about a desired route on a client device 200b, according to an embodiment. The application can be mobile, web-based, or run on any suitable computing device, such as client device 200b. The home graphical user interface 300 may be displayed on the client device 200b and enables route finding to be performed from the client device 200b.

The first graphical user interface 300 (or home GUI 300) can enable a user to quickly enter travel data about a route using several parameters. The first graphical user interface 300 may include a graphical organizer container 302 and one or more graphical data containers 304. The one or more graphical data containers 304 may be nested in the graphical organizer container 302. The find routes graphical organizer container 302 has graphical user interface elements including a set distance text box 306, and a set destination textbox 308, and an explore button 318. The distance travel data (or parameters) are entered in the set distance text box 306. The set distance textbox 306 allows the user to choose a desired distance for the route. The distance can be set in feet, meters, yards, miles, kilometers, or various units of measurement. A second parameter (travel data) is entered in the set destination textbox 308 in which the user chooses a final or intermediary destination for the route. The route can begin at the current location of the user, or a secondary location chosen by the user.

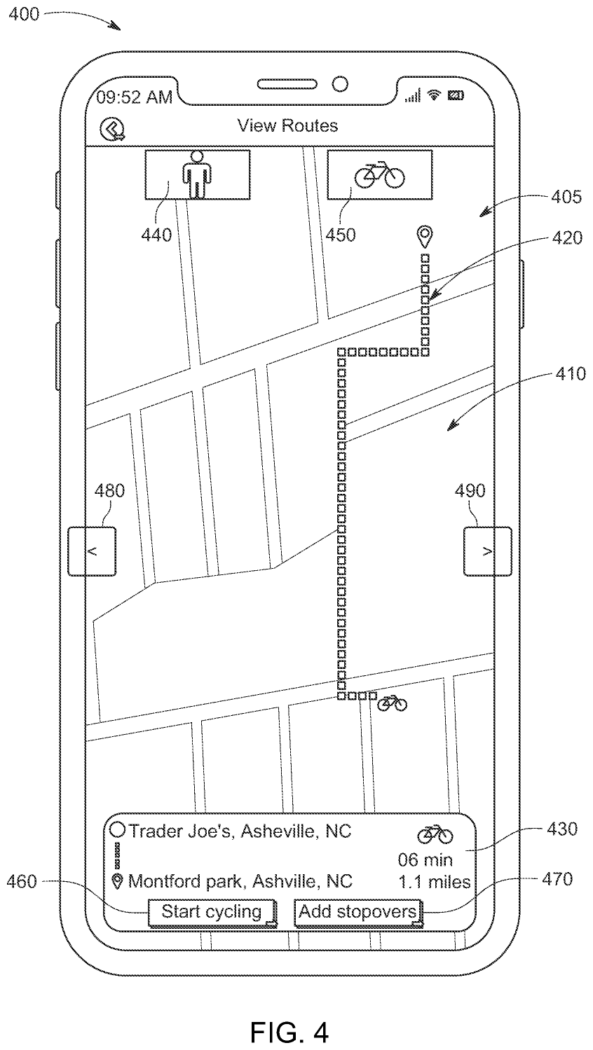

The explore button 318 will execute the travel data (or parameters) entered in the textboxes (306, 308) and create a route based on the travel data (or parameters) chosen by the user. The route finder utility 100 analyzes the travel data (or parameters) via processing devices 210 and provides up to five routes from which the user can choose. An example of a route is illustrated below in FIG. 4.

An individual graphical data container 304 can include a variety of travel information (or parameters) that can be employed to create custom routes. The travel information can be entered in textboxes, and include information such as distance, start time, first location, final destination, and/or stopover location.

As used herein, travel information/travel data/parameter may refer to a data object of a software application. The travel information/travel data/parameter may be referential, e.g., may reference to a particular data location. System memory for the travel information/travel data/parameter may be drawn from a pool of memory allocated for the software application. The software application may include instructions to request a pool of memory sized based on permissions granted to the software application. An application running on a remote device may change the permissions associated with the local software application. The software application may include instructions to request greater memory allocation based on being granted additional permissions.

FIG. 3 further illustrates a second graphical organizer container 330 entitled recent routes (recent routes graphical organizer container 330). The recent routes graphical organizer container 330 includes multiple recent route graphical data containers 332, 334, 336 that provide information about prior routes chosen and/or used by the user. These routes can be from a first location to a second location, or round-trip routes. Further, the routes can be pre-set routes that other users have used in the location. The preset routes can be accessed from memory devices and/or storage devices on the server device 200a, stored in memory device 210 or cloud storage, or other remote storage locations.

The recent routes graphical data containers 332, 334, 336 can include information about the recent routes including maps, distance, time to complete the route, number of stops, steps, heartrate, pulse, type of locomotion (i.e., walk, run, bike, rollerblade, and various other means of locomotion). The recent routes graphical data containers 332, 334, 336 can further include the start and end point of the route as well as the name of any stops on the route. The recent routes can be organized by distance, time, most recently used, most frequently used, and combinations thereof. The route finder utility is configured to save routes, display the routes for later use, and share routes with other users. The recent routes graphical data containers 332, 334, 336 further includes a view details button 370 that will send the user to a view route graphical user interface 400 (see FIG. 4).

FIG. 3 further illustrates a Home button 340, a My Routes button 350, and a Profile button 360 for the route finder utility 100. The Home button 340, My Routes button 350, and Profile button 360 buttons can be accessed from the Home graphical user interface 300 and will send the user to the Home GUI, the My Routes GUI and Profile GUI respectively. The buttons 340, 350 and 360 can be located together at a lower portion of the Home graphical user interface 300 or they can be located at the top of the Home graphical user interface 300.

A system including a data processing system can include a route finder utility configured to create custom routes. The route finder utility further includes a graphical user interface including a home graphical user interface, a view routes graphical user interface, a my route graphical user interface, and a profile graphical user interface. A processing device configured to create custom travel routes, wherein the processing device creates custom travel routes in view of travel data including distance, start location, an end location, stopover destinations, and start time. A data storage system can include travel information including maps, weather, and safety information. The route finder utility is configured to find custom travel routes via input from a user, process the inputs via the processing device and create custom travel routes via the processing device and information stored in the data storage system. The route finder utility is further configured to generate graphical user interfaces on a client device accessible by the user, wherein the client device is configured to display real-time location and travel data via cellular communications or global positioning systems.

The route finder utility can be configured to generate graphical user interfaces on a smart device selected from the group including smart cellular phones, smart watches, smart wearables, and combinations thereof. The route finder utility can be configured to allow the user to provide travel data via a mouse, a keypad, a touch screen, or a microphone.

The route finder utility is configured to generate custom maps, via the processor and data storage systems, and wherein the custom routes can be generated based on distance, time, starting location, or end destination.

The route finder utility is configured to alter the custom route in view of stopovers, locomotion mode, weather, safety data, crime data, or starting time. The safety data stored in the data storage system comprises crime statistics, road safety information, road construction information, and hazardous weather information. The maps stored in the data storage system comprise data comprising streets, paths, bike routes, running routes, dirt roads, and hiking trails. The route finder utility is further configured to access online databases, such as Google Maps, and other interactive mapping systems to assist with generating routes. The route finder utility can access crime information, weather information, traffic information, construction information and other sources of information to assist with preparing optimal routes for distance, safety, and other features chosen by the user.

FIG. 4 illustrates a view routes graphical user interface 400, according to an embodiment. The View Routes GUI 400 includes a graphical organizer container 405 that includes an interactive map 410 that depicts a route 420. The route 420 can be a prior route saved by the route finder utility 100, a new route created based on parameters chosen by the user, or a stored route from other users. The interactive map 410 can be expanded to show additional areas or shrunk to highlight specific locations. The View Routes GUI 400 can include a graphical data container 430 that includes information on the route including, starting location, ending destination, the mode of locomotion (including an icon for each mode of locomotion, e.g., walking, running, biking, rollerblading, and various other modes), total distance, distance covered, time for distance covered, and estimated time for total distance, and/or speed.

The View Routes GUI 400 can further include buttons separate from the graphical data container 430 that can be toggled based on the mode of transportation. As illustrated in FIG. 4, a walking button 440 and bicycle button 450 can be pressed to change the type of locomotion employed for the route.

The route description graphical date container 430 can include a start button 460 to start the route, and an add stopover button 470 to add destinations to the route. Engaging the start button 460 will begin the timer for the route and GPS will track the user. The add stopover button 470 functions are described below.

The View Routes GUI 400 further includes at least two navigation buttons 480, 490 located at the sides of the screen of the client device 200b. The navigation buttons 480, 490 allow the user to toggle between routes. The left or previous navigation button 480 shows prior routes, and the right or next navigation button 490 shows additional routes.

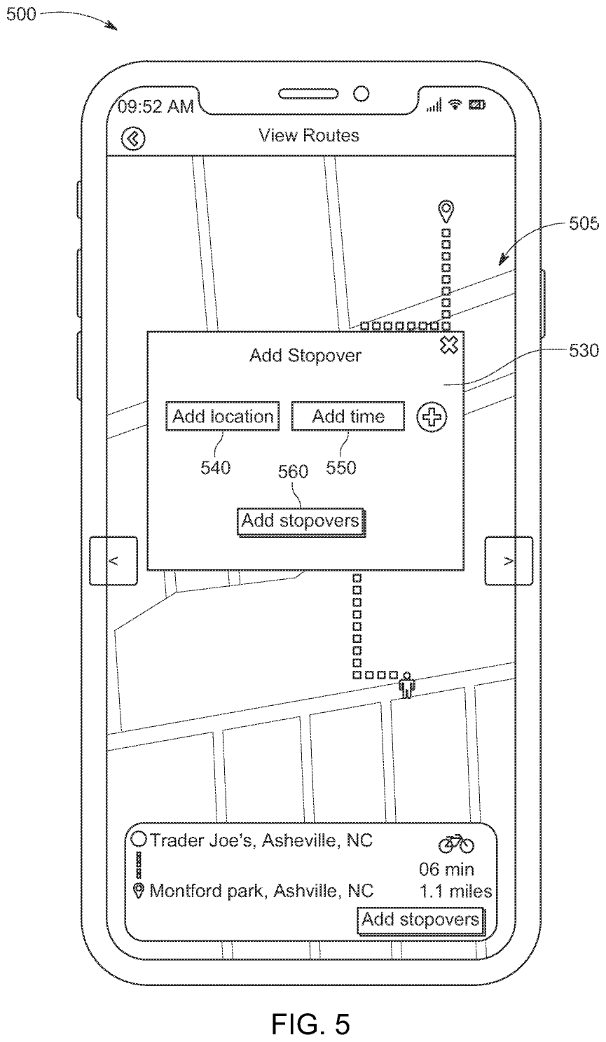

FIG. 5 illustrates a View Route GUI 500, with an add stopover graphical data container 530 nested within a graphical organizer container 505, according to an embodiment. FIG. 5 illustrates the add stopover graphical data container 530 that will activate after a user engages the add stopover button 470 on the View Routes GUI 400. The add stopover graphical data container 530 further contains an add location textbox 540, and add time text box 550, and an add stopover button 560. The add location textbox 540 allows the user to add locations to add to the route. The locations can be added in text format and the processing device 212 will locate the closest approximations to the text format. The add time textbox 550 will allow the user to add a set amount of time to the route for the stopover, and the add stopover button 560 will create additional add stopover graphical data containers 530a, 530b to allow the user to add locations and times to the route and/or will execute the addition of the stopover.

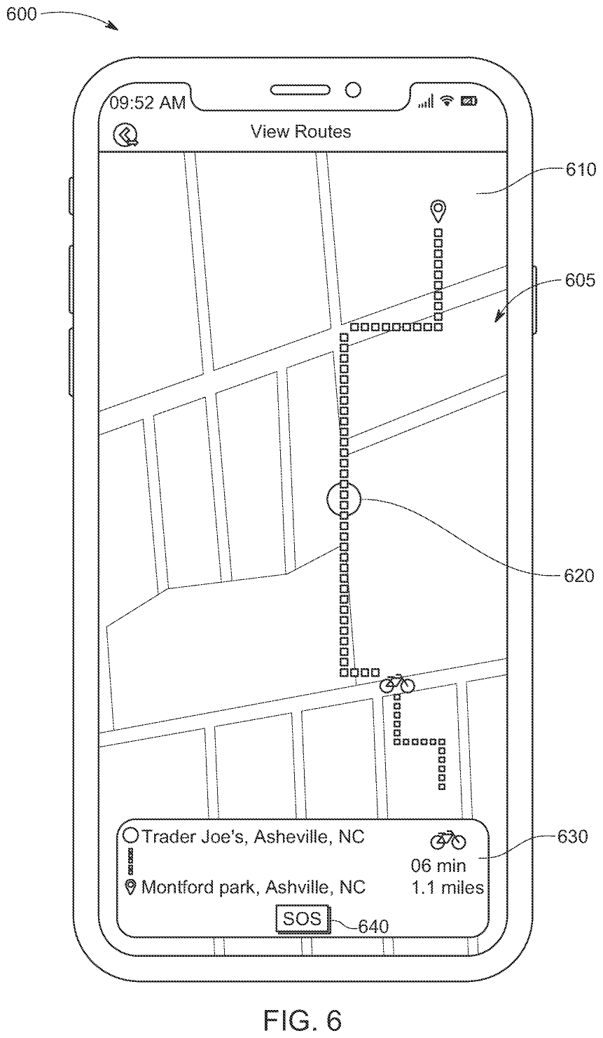

FIG. 6 illustrates the View Routes GUI 600 indicating a stopover 620, according to an embodiment. The interactive map 610 depicted on the View Routes GUI 600 includes a stopover 620 that has been added to a route by a user. Additional stopovers 620a, 620b, 620c, can be added to the route as demonstrated above and in FIG. 5.

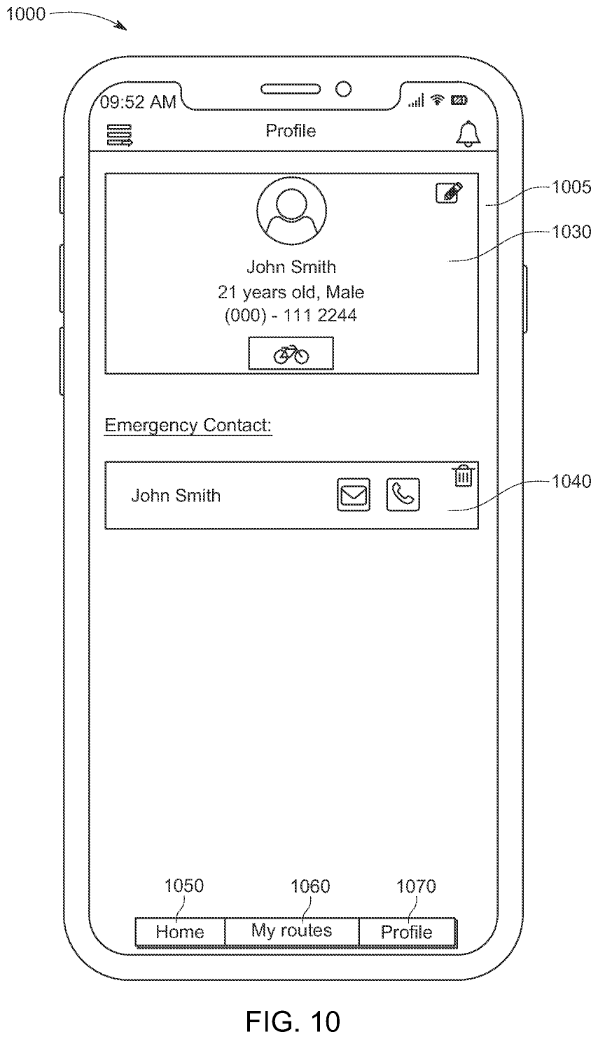

FIG. 6 further illustrates the View Routes GUI 600 while the route is being employed by the user. While the user is actively engaged with traversing the route, the route description graphical data container 630 nested within a graphical organizer container 605 can include an SOS (save our souls) button 640 that can allow the user to notify others that the user needs assistance. The SOS button 640 is linked to preprogrammed information set by the user in the Profile GUI (sec FIG. 10). Once engaged the SOS button 640 will send text, phone, video, and/or image data transmissions to emergency contacts. Additionally, the SOS can be set to alert local law enforcement, 911 operators, fire departments, emergency medical technicians (EMTs), police, hospitals, and other emergency professionals or personnel. Embodiments of the route finder utility will only contact individuals listed in the emergency contact database via text messages. The SOS feature can be changed based on user preference. The information associated with the SOS can provide the name of the user, the route taken by the user, start times, estimated end times, and the current location of the user to the emergency contact and/or emergency personnel.

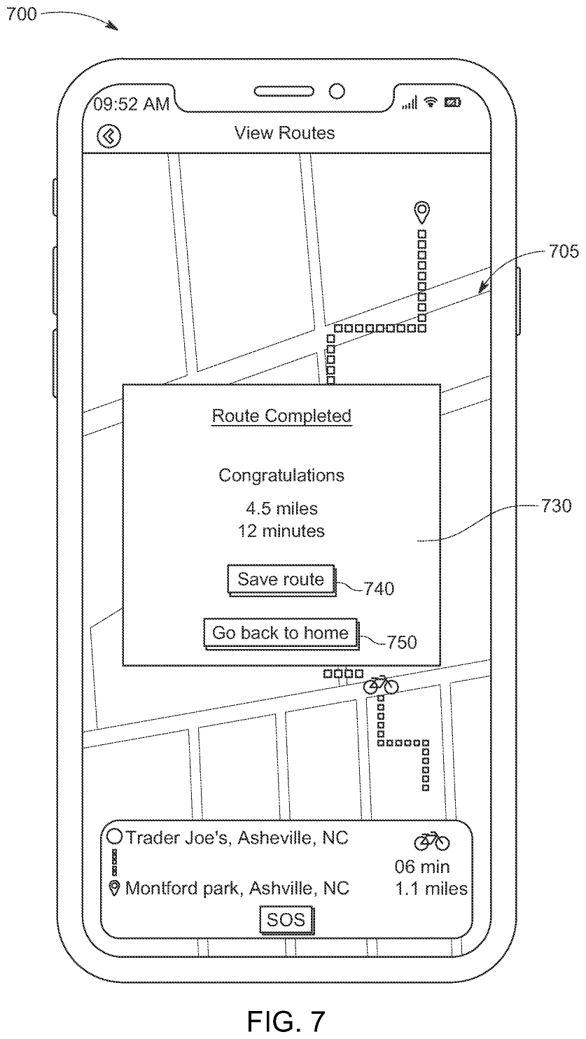

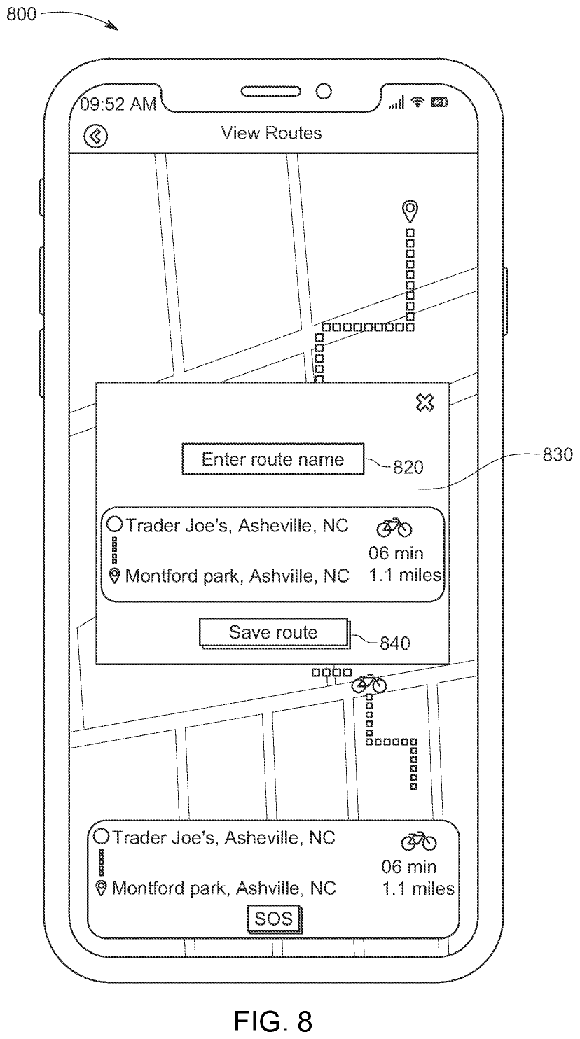

FIG. 7 illustrates a View Routes GUI 700 including a route completed graphical data container 730, according to an embodiment. The route completed graphical data container 730, which can be nested within a graphical organizer container 705, can include information related to the route, including distance, time, locations, speed, notifications to the user such as congratulations, number of routes completed, number of miles/km in a week/month/year, and various other notifications. The route completed graphical data container 730 can further include a save route button 740 and a go back to home button 750. The save route button 740 will allow the user to save the route and later name the route for case of finding the saved route (see FIG. 8). The go back to home button 750 will return the user to the home GUI 300.

FIG. 8 illustrates the view route GUI 800 including a save route graphical data container 830 according to an embodiment. The save route graphical data container 830 can include an enter route name textbox 820 where the user can provide a text-based name for the recently completed route. The route can be depicted in the save route graphical data container 830 (as illustrated in FIG. 8). A save route button 840 can be located within the save route graphical data container 830 allowing the user to save the recently completed route under the new route name provided by the user. The newly saved route will be stored in the memory device 210 associated with the client device 200b and can also be saved at remote locations including cloud storage and/or remote servers.

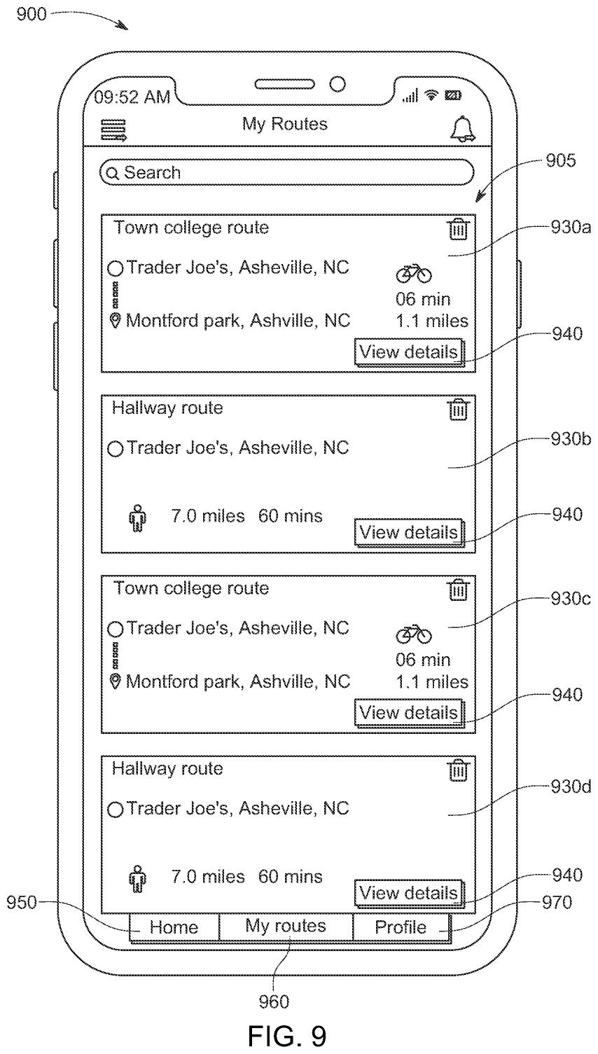

FIG. 9 illustrates a My Routes GUI 900 according to an embodiment. The My Routes GUI 900 contains a graphical organizer container 905 in which multiple saved route graphical data containers 930a, 930b, 930c, 930d can be nested. The saved route graphical data containers 930a, 930b, 930c, 930d can include information about the saved routes including destinations (multiple destinations if not a round-trip route), distance, time, locomotion mode, and various other information. The saved route graphical data containers 930a, 930b, 930c, 930d, can include view details buttons 940 that allow the user to access the view route GUI and the interactive maps associated with the routes. The Home button 950, My Routes button 960, and Profile button 970 buttons can be accessed from the My Routes GUI 900 and will send the user to the Home GUI, the My Routes GUI, and Profile GUI respectively.

FIG. 10 illustrates the Profile GUI 1000, according to an embodiment. The Profile GUI 1000 can include a graphical organizational container 1005 and a profile graphical data containers 1030 that includes information about the user, including, name, age, weight, medical information (such as allergies, medications, illnesses, and/or other medical information), phone number, e-mail address, user name, as well as other personal information. The profile GUI 1000 can further include an emergency contact graphical data container 1040 that contains information related to emergency contacts and/or emergency personnel to be employed in emergency situations, including the SOS feature described in FIG. 6 above. The Home button 1050, My Routes button 1060, and Profile button 1070 buttons can be accessed from the Profile GUI 1000 and will send the user to the Home GUI, the My Routes GUI and Profile GUI respectively.

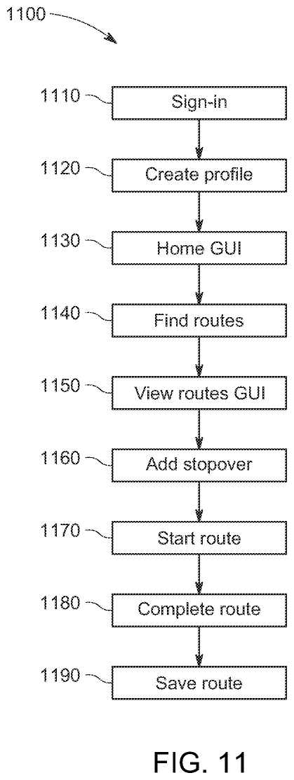

FIG. 11 illustrates a flow chart 1100 depicting methods steps to operate the route finder utility 100 according to an embodiment. In step 1110 the user signs into the route finder utility 100. The sign in step 1110 can include an e-mail and password sign-in, or the user can sign in using social media utilities (or platforms), such as Facebook, Google, Apple, LinkedIn, Snap Chat, and various other social media utilities (platforms/websites/software applications). A reset e-mail can be sent to the user with a link for a one-time sign-in, or to reset the password.

In step 1120 the user creates a profile. The profile information can include name, profile picture, phone number, date of birth, gender, locomotion mode preference (e.g., walking, running, cycling, rollerblading, and other locomotion mode) emergency contact information (e.g., name, e-mail address, phone number, and/or relation to user).

In step 1130 the user is shown the home GUI that will provide access to Profile GUI, Home GUI, and My Routes GUI.

In step 1140 the user can access the Find Routes graphical data container which can allow the user to create routes via distance and/or destination(s). By using the set distance textbox the user can specify a specific distance to cover, such as 5 kilometers, 5 miles, 1500 yards, 2000 feet, and variations thereof. The route finder utility 100 will suggest multiple routes for the user to choose from (e.g., two, three, four, five, etc. . . . ). If the user does not suggest multiple destinations in the next step the route will default to a round trip route from the current location. In the set destination function the user can enter a location for the end of the route. If a beginning location is not chosen, the current location will be set as the starting location of the route. The route finder utility 100 can then suggest multiple (e.g., two, three, four, five) routes for the user to choose from.

In step 1150 the user can access the view routes GUI which can provide the user with an interactive map depicting the specific route chosen by the user. In the view routes GUI the user can access additional routes via a next and previous button. Within the view routes GUI the user can toggle between means of locomotion (e.g., walking, running, bicycling, rollerblading, and as well as others means of locomotion). By changing the locomotion mode the route finder utility will calculate various estimated times for the completion of the route.

Within the view routes GUI the user can access several operations including, add stopovers, start locomotion, and route completion.

In step 1160 the user can add a stopover via engaging the add stopover button. and entering information related to a stopover including location and time. The route finder utility 100 will save the location information within the route and not include the time spent at the stopover in the total time for the route (i.e., the timer is paused while at the stopover).

In step 1170 the user can engage the start locomotion button, to begin traversing the route. The route finder utility 100 will display a live interactive map tracking the user via GPS and/or other cellular communication systems. At any time while using the route finder utility 100 (either while the route is being traversed, during a stopover, or while the route finder utility is idle) the user can engage the SOS button to send an SOS emergency transmissions, such as a message, email, text, phone call, video call, and/or image to the emergency contact (and/or emergency systems, including police, EMS, fire department, and variations thereof). The SOS transmission can include name, location, route, time, medical information, accident information, weather, images, video, audio, and/or additional messages from the user.

In step 1180 after the user has completed the route a route completion graphical data container will notify the user that the route has been completed. The route completion graphical data container will include information such as the distance covered, time for completion of the route, the route, and the means of locomotion.

In step 1190 the user can save the route via a save route button that will open a save route graphical data container allowing the user to enter a text-based name for the newly completed route. The saved route can then be available from the My Routes GUI. After the route has been saved the user will be presented with a home button/icon that can send the user to the home GUI.

Embodiments of methods can include granting, via a processor, access by a user to a route finder utility, wherein the access is via a graphical user interface. Storing, to a data storage system, data comprising maps, weather information, and safety data. Selecting, by a processor, a route finder utility, wherein the route finder utility is configured to enable a user to provide custom travel information comprising distance, start location, end destination, stopover destination, and locomotion preference. Executing a custom route via the processing device and the data storage system. Generating the graphical user interface on a client device accessible by the user, wherein the graphical user interface comprises a home graphical user interface, a view routes graphical user interface, a my routes graphical user interface, and a profile graphical user interface. Enabling the user to amend the route via the graphical user interface via inclusion of a new distance, new stopovers, a new end destination, a new start time, or a new start location.

Embodiments include enabling, by the processor, a user to access a real-time interactive map via the view routes graphical user interface, and enabling, by the processor, a user to amend the route in real-time.

Embodiments include enabling, by the processor, a user to send an SOS message to emergency contacts, wherein the emergency contact are created by the user and stored in a profile database in the data storage system.

Embodiments include enabling, by the processor, the user to change the locomotion mode, wherein the locomotion mode can be selected from the group consisting of walking, running, bicycling, rollerblading, skateboarding, swimming, and combinations thereof.

Embodiments include providing, by the processor, a login feature to ensure authorized user access to the route finder utility.

Embodiments include providing, by the processor, information about routes of third parties that are connected to the user via granting access to the route finder utility, wherein the access is granted by the user, and the user and the third party can interact on the route finder utility in real-time. Additional embodiments can include the processor processing data including user login information and third-party login information to ensure privacy of the user's real-time information.

Embodiments of a system can include a route finder utility comprising a graphical user interface. The graphical user interface can include utilities configured for inputting travel data comprising distance, start location data, end destination data, stopover data, locomotion mode, and start time data. Inputting profile data can include items such as user name, user gender, user height, user weight, user exercise level, and user emergency contact information. The graphical user interface can further include an interactive real-time map configured to provide a custom route for the user.

Embodiments of the route finder utility can be configured to generate graphical user interfaces to a client device, and the graphical user interface further including a home graphical user interface, a view routes graphical user interface, a my routes graphical user interface, and a profile graphical user interface.

Embodiments of the route finder utility can include a home graphical user interface configured to input, via a processing device, travel data including distance, start location, end destination, stopovers, and locomotion mode. The route finder utility is further configured to generate, via the processor and data storage system, custom routes created for the user by the route finder utility.

Embodiments of the route finder utility can include a my routes graphical user interface configured to store, via the data storage system, custom routes created for the user by the route finder utility, store, via the data storage system, routes taken by the user, and transmit routes stored in the data storage system to a client device. The view routes graphical user interface can be further configured to generate, via a processing device, a real-time interactive map comprising distance traveled, start location, end destination, stopovers, and locomotion mode. The view routes graphical user interface can be further configured to generate, via the processor and data storage system, real-time route information on the real-time interactive map.

Embodiments of the route finder utility can include a profile graphical user interface configured to include emergency contact information. The emergency contact information can be employed, via the processor, to generate an emergency SOS message when the user initiates an SOS message or the route finder utility determines, via the processing device an accident has occurred. The SOS message can be sent to emergency contacts stored in the data storage system, or emergency professionals selected from the group including hospitals, 911, fire departments, emergency medical technicians, police, and combinations thereof.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A system, comprising:
a data processing system comprising:
a route finder utility configured to create routes, the route finder utility comprising:
a graphical user interface,
wherein the graphical user interface comprises:
a home graphical user interface,
a view routes graphical user interface,
a my route graphical user interface, and
a profile graphical user interface,
a processing device configured to create routes,
wherein the processing device creates routes in view of travel data comprising:
a distance,
a start location,
an end location, and
stopover destinations,
a data storage system comprising travel information comprising:
maps,
weather, and
safety data,
wherein the route finder utility is configured to find routes via input from a user, process the input via the processing device and create routes via the processing device and information stored in the data storage system; and
the route finder utility further configured to generate graphical user interfaces on a client device accessible by the user, and wherein the client device is configured to display real-time location and travel data via cellular communications or global positioning systems.

2. The system of claim 1, wherein:
the route finder utility can be configured to generate graphical user interfaces on a smart device selected from the group including smart cellular phones, smart watches, smart wearables, and combinations thereof.

3. The system of claim 1, wherein:
the route finder utility is configured to allow the user to provide travel data via a mouse, a keypad, a touch screen, or a microphone.

4. The system of claim 1, wherein:
the route finder utility is configured to generate custom maps, via the processing device and data storage system, and wherein the routes can be generated based on:
distance,
starting location, or
end destination.

5. The system of claim 4, wherein:
the route finder utility is configured to alter the route in view of:
stopovers,
locomotion mode, or
starting time.

6. The system of claim 1, wherein:
the safety data stored in the data storage system comprises:
crime statistics,
road safety information,
road construction information, and
hazardous weather information.

7. The system of claim 1, wherein the maps stored in the data storage system comprise data comprising:
streets,
paths,
bike routes,
running routes,
dirt roads, and
hiking trails.

8. A method comprising:
granting, via a processor, access by a user to a route finder utility;
wherein the access is via a graphical user interface,
storing, to a data storage system, data comprising:
maps,
weather information, and
safety data,
selecting, by a processor, a route finder utility,
wherein the route finder utility is configured to:
enable a user to input route data comprising:
distance,
start location,
end destination,
stopover destination, and
locomotion preference;
executing a route via a processing device and a data storage system;
generating the graphical user interface on a client device accessible by the user,
wherein the graphical user interface comprises:
a home graphical user interface,
a view routes graphical user interface,
a my routes graphical user interface, and
a profile graphical user interface; and
enabling the user to amend the route via the graphical user interface via inclusion of:
a new distance,
new stopovers,
a new end destination,
a new start time, or
a new start location.

9. The method of claim 8, further comprising:
enabling, by the processor, a user to access a real-time interactive map via the view routes graphical user interface, and
enabling, by the processor, a user to amend the route in real-time.

10. The method of claim 9, further comprising:
enabling, by the processor, a user to send an SOS message to an emergency contact,
wherein the emergency contact is created by the user and stored in a profile database in the data storage system.

11. The method of claim 10, further comprising:
enabling, by the processor, the user to change locomotion mode,
wherein the locomotion mode can be selected from the group consisting of walking, running, bicycling, rollerblading, skateboarding, swimming, and combinations thereof.

12. The method of claim 8, further comprising:
providing, by the processor, a login feature to ensure authorized user access to the route finder utility.

13. The method of claim 8, further comprising:
providing, by the processor, information about routes of third parties that are connected to the user via granting access to the route finder utility,
wherein the access is granted by the user, and the user and the third party can interact on the route finder utility in real-time.

14. The method of claim 13, wherein:
the processor processes data comprising user login information and third-party login information to ensure privacy of the user's real-time information.

15. A system comprising:
a route finder utility comprising a graphical user interface,
wherein the graphical user interface comprises utilities configured for:
inputting route data comprising:
distance,
start location,
end destination,
stopover,
locomotion mode, and
start time, and
inputting profile data comprising:
user name,
user gender,
user height,
user weight,
user exercise level, and
user emergency contact information, and
the graphical user interface further comprising:
an interactive real-time map configured to provide a route for a user.

16. The system of claim 15, wherein:
the route finder utility is configured to generate graphical user interfaces to a client device, and the graphical user interface further comprises:
a home graphical user interface,
a view routes graphical user interface,
a my routes graphical user interface, and
a profile graphical user interface.

17. The system of claim 16,
comprising a home graphical user interface, wherein the home graphical user interface is configured to:
input, via a processing device, travel data comprising:
distance,
start location,
end destination,
stopovers, and
locomotion mode; and
generate, via the processing device and a data storage system, routes created for the user by the route finder utility.

18. The system of claim 17,
comprising a my routes graphical user interface, wherein the my routes graphical user interface is configured to:
store, via the data storage system, routes created for the user by the route finder utility,
store, via the data storage system, routes taken by the user, and
transmit routes stored in the data storage system to a client device.

19. The system of claim 18,
comprising a view routes graphical user interface, wherein the view routes graphical user interface is configured to:
generate, via a processing device, a real-time interactive map comprising:
distance traveled,
start location,
end destination,
stopovers, and
locomotion mode;
wherein the view routes graphical user interface is further configured to generate, via the processing device and data storage system, real-time route information on the real-time interactive map.

20. The system of claim 19,
comprising a profile graphical user interface, wherein the profile graphical user interface is configured to:
include emergency contact information,
wherein the emergency contact information can be employed, via the processing device, to generate an emergency SOS message when the user initiates an SOS message or the route finder utility determines, via the processing device an accident has occurred,
wherein the SOS message can be sent to emergency contacts stored in the data storage system, or emergency professionals selected from the group including hospitals, 911, fire departments, emergency medical technicians, police, and combinations thereof.
